(19) United States
(12) Patent Application Publication
(10) Pub. No.: US 2026/0144700 A1
(43) Pub. Date: May 28, 2026

(54) UNIT DRIVING APPARATUS

(71) Applicants: TOYOTA BOSHOKU KABUSHIKI KAISHA, Aichi (JP); TOHOKU UNIVERSITY, Miyagi (JP)

(72) Inventors: Koji KANEDA, Toyota-shi (JP); Kazuki ABE, Sendai-shi (JP)

(73) Assignees: TOYOTA BOSHOKU KABUSHIKI KAISHA, Aichi (JP); TOHOKU UNIVERSITY, Miyagi (JP)

(21) Appl. No.: 19/353,123

(22) Filed: Oct. 8, 2025

(30) Foreign Application Priority Data
Oct. 15, 2024 (JP) 2024-179855

(51) Int. Cl. A61H 15/00

(52) U.S. Cl. CPC A61H 15/0078; A61H 2015/0014; A61H 2201/0149; A61H 2201/1215; A61H 2203/0425

(57) ABSTRACT

A unit driving apparatus includes a guide rail including at least one guide groove, a moving unit displaceable along the guide rail, and a first drive part and second drive part disposed inside at least one guide groove. The moving unit includes a first joint part joined to the first drive part, a second joint part joined to the second drive part, a displacement part, and a mechanism part joined to the first joint part and second joint part. The mechanism part displaces the displacement part so that the displacement part approaches and leaves the guide rail as the second joint part is displaced relative to the first joint part.

### CROSS-REFERENCE TO RELATED APPLICATIONS

This application claims the benefit of Japanese Patent Application No. 2024-179855 filed on Oct. 15, 2024, the entire disclosures of which are incorporated herein by reference.

### BACKGROUND

The present disclosure relates to a unit driving apparatus configured to drive a moving unit.

For example, Japanese Unexamined Patent Application Publication No. 2003-180780 discloses a massager. The massager includes a guide rail, and moving units disposed on the guide rail and continuously movable along the guide rail. The moving units massage a user by pressing a desired body part of the user.

### SUMMARY

In the massager disclosed in Japanese Unexamined Patent Application Publication No. 2003-180780, a pad member for supporting a body of the user cannot be disposed within a movable range of the moving units. Meanwhile, the user of the massager tends to feel discomfort with a portion where the pad member is not disposed in the massager. Therefore, in order to reduce discomfort of the user, it is desirable to downsize the moving units.

Meanwhile, a power source, such as a motor, needs to be incorporated in the moving units to raise and lower a part of the moving units with respect to the guide rail. This might increase a size of the moving unit.

In one aspect of the present disclosure, it is desirable that a moving unit can be downsized.

One aspect of the present disclosure is a unit driving apparatus including a guide rail, a moving unit, a first drive part, and a second drive part. The guide rail extends in a longitudinal direction and includes at least one guide groove extending along the longitudinal direction. The moving unit is configured to be displaceable along the guide rail. The first drive part and the second drive part are disposed to extend along the longitudinal direction inside the guide groove, and are configured to be displaceable along the longitudinal direction independently of each other. The moving unit includes a first joint part, a second joint part, a mechanism part, and a displacement part. The first joint part is joined to the first drive part. The second joint part is joined to the second drive part and is configured to be displaceable relative to the first joint part in the longitudinal direction. The mechanism part is joined to the first joint part and the second joint part. The displacement part is configured to be displaceable so as to approach and leave the guide rail. The mechanism part is configured to displace the displacement part so that the displacement part approaches and leaves the guide rail as the second joint part is displaced relative to the first joint part in the longitudinal direction.

According to the above-described configuration, drive force for driving the moving unit is transmitted from a power source to the moving unit via the first drive part and the second drive part. Therefore, without incorporating a power source such as a motor into the moving unit, it is possible to allow the moving unit to be displaced along the guide rail, and allow the displacement part to approach and leave the guide rail. Therefore, the moving unit can be downsized.

In one aspect of the present disclosure, the guide rail may include a plurality of joint members aligned in the longitudinal direction while being turnably joined to each other.

According to the above-described configuration, the guide rail can be deformed in response to an external force. Therefore, the moving unit can be displaced along the deformed guide rail.

In one aspect of the present disclosure, the mechanism part may include a first link and a second link. A first end side of the first link may be turnably joined to the first joint part, and a second end side of the first link may be turnably joined to the displacement part. A first end side of the second link may be turnably joined to the second joint part, and a second end side of the second link may be turnably joined to the displacement part.

According to the above-described configuration, it is possible to allow the displacement part to favorably approach and leave the guide rail.

In one aspect of the present disclosure, the first link and the second link may intersect each other, and may be turnably joined to each other at a portion where the first link and the second link intersect each other.

According to the above-described configuration, it is possible to allow the displacement part to favorably approach and leave the guide rail.

In one aspect of the present disclosure, the second joint part may include a guide extending obliquely along the longitudinal direction so as to leave the guide rail, from a side on which a portion where the first link and the first joint part are joined to each other is positioned toward a side on which a portion where the second link and the second joint part are joined to each other is positioned. The second link may include a pin. The pin may be disposed in the guide so as to be displaceable along a direction in which the guide extends.

According to the above-described configuration, it is possible to allow the displacement part to favorably approach and leave the guide rail.

In one aspect of the present disclosure, the mechanism part may include a plate-shaped part that is bendable and extending along the longitudinal direction. The displacement part may be a part of the plate-shaped part. The mechanism part may be configured to change a curvature of a bent of the plate-shaped part as the second joint part is displaced relative to the first joint part in the longitudinal direction.

According to the above-described configuration, it is possible to allow the displacement part to favorably approach and leave the guide rail.

In one aspect of the present disclosure, the mechanism part may include a first piece and a second piece. The first piece may be turnably joined to the first joint part. The second piece may be turnably joined to the second joint part. The displacement part may be a part that turnably joins the first piece and the second piece to each other. Furthermore, the mechanism part may be configured to change an angle formed at the displacement part by the first piece and the second piece, as the second joint part is displaced relative to the first joint part in the longitudinal direction.

According to the above-described configuration, it is possible to allow the displacement part to favorably approach and leave the guide rail.

In one aspect of the present disclosure, the guide rail may include a first guide groove and a second guide groove as at least one guide groove. The first drive part may be disposed inside the first guide groove. The second drive part may be disposed inside the second guide groove.

According to the above-described configuration, the first drive part and the second drive part can be favorably displaced.

In one aspect of the present disclosure, a first motor that outputs drive force for displacing the first drive part, and a second motor that outputs drive force for displacing the second drive part may be included.

According to the above-described configuration, the first drive part and the second drive part can be favorably displaced by the first motor and the second motor.

In one aspect of the present disclosure, the unit driving apparatus may be mounted on a chair. The unit driving apparatus may be configured to press a body part of a seated person on the chair by displacing the displacement part so that the displacement part leaves the guide rail.

According to the above-described configuration, it is possible to massage the seated person by pressing the body part of the seated person by using the unit driving apparatus.

### BRIEF DESCRIPTION OF THE DRAWINGS

An example embodiment of the present disclosure will be described hereinafter with reference to the accompanying drawings, in which:

FIG. 1 is a view showing a unit driving apparatus according to a first embodiment;

FIG. 2 is an oblique view showing a moving unit of the first embodiment;

FIG. 3A is a perspective view of the moving unit according to the first embodiment as viewed from left in which a displacement part is lowered;

FIG. 3B is a perspective view of the moving unit according to the first embodiment as viewed from the left in which the displacement part is raised;

FIG. 4A is an oblique view showing a part of the moving unit according to the first embodiment in which the displacement part is lowered;

FIG. 4B is an oblique view showing a part of the moving unit according to the first embodiment in which the displacement part is raised;

FIG. 5 is a view of a part of the moving unit according to the first embodiment as viewed transparently from above in which the displacement part is lowered;

FIG. 6A is an oblique view showing a moving unit according to a second embodiment in which a displacement part is lowered;

FIG. 6B is an oblique view showing the moving unit according to the second embodiment in which the displacement part is raised;

FIG. 7A is a view showing a moving unit according to another embodiment in which a displacement part is lowered;

FIG. 7B is a view showing the moving unit according to the another embodiment in which the displacement part is raised; and

FIG. 8 is a view showing the moving unit according to a modification of the second embodiment.

### DETAILED DESCRIPTION OF EXEMPLARY EMBODIMENTS

### 1. First Embodiment

### [1-1. Overall Configuration]

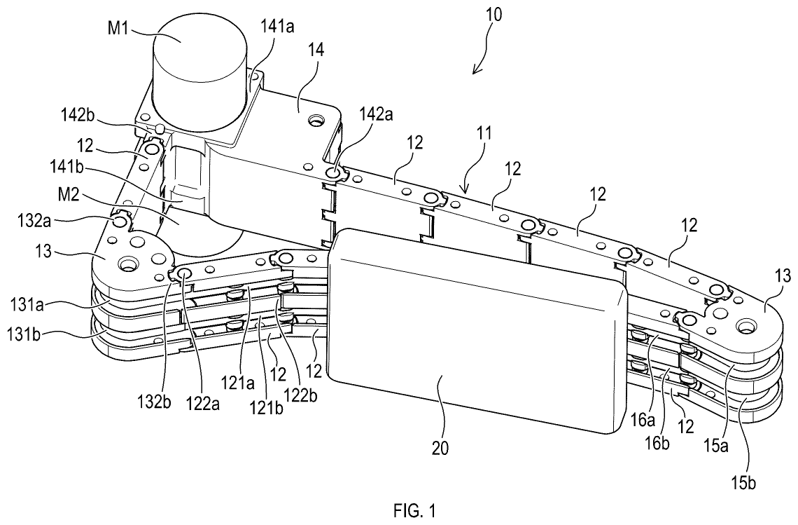

A unit driving apparatus 10 according to the present embodiment is configured to drive a moving unit 20 installed on a guide rail 11 (refer to FIG. 1). As an example, the unit driving apparatus 10 is mounted on a chair having a massage function, and is used to press a body part of a seated person. However, the unit driving apparatus 10 is not limited thereto, and may be used for other purposes, for example, for a conveyance apparatus for conveying an object.

The unit driving apparatus 10 includes the guide rail 11, first and second belts 16a, 16b, first and second motors M1, M2, and the moving unit 20.

### [1-2. Guide Rail]

The guide rail 11 is an elongated flat member and forms an annular shape having an outer peripheral surface and an inner peripheral surface. The guide rail 11 includes a plurality of plates 12, a plurality of connection members 13, and a motor attachment part 14 (refer to FIG. 1). The plurality of plates 12, the plurality of connection members 13, and the motor attachment part 14 are aligned in a circumferential direction, and are turnably joined to each other. The guide rail 11 includes first and second guide grooves 15a, 15b on the outer peripheral surface thereof. The first and second guide grooves 15a, 15b extend along the circumferential direction.

The plurality of plates 12 is flat members extending in the circumferential direction. Two surfaces of each plate 12, the surfaces facing each other in a thickness direction, form the inner peripheral surface and outer peripheral surface of the guide rail 11. First and second grooves 121a, 121b are provided on a surface of each plate 12, the surface forming the outer peripheral surface of the guide rail 11. The first and second grooves 121a, 121b extend from a first end to second end of each plate 12 along the circumferential direction.

Each plate 12 has first and second joint portions 122a, 122b at the first end and the second end in the circumferential direction, respectively. The first joint portion 122a of each plate 12 is turnably joined to the second joint portion 122b of another plate 12. When each plate 12 is joined to another plate 12, each first groove 121a is connected to each other, and each second groove 121b is connected to each other.

The plurality of connection members 13 is members joined to the plates 12. A surface of each connection member 13, the surface forming the outer peripheral surface of the guide rail 11, is bent so as to protrude toward an outer peripheral side of the guide rail 11. The surface is provided with first and second grooves 131a, 131b. The first and second grooves 131a, 131b extend from a first end to second end of each connection member 13 in the circumferential direction. Each connection member 13 has first and second joint portions 132a, 132b at both ends on the surface in the circumferential direction.

The first joint portion 132a of each connection member 13 is turnably joined to the second joint portion 122b of a plate 12. The second joint portion 132b of each connection member 13 is turnably joined to the first joint portion 122a of a plate 12. When each connection member 13 is joined to a plate 12, the first groove 131a of the connection member 13 is joined to the first groove 121a of the plate 12, and the second groove 131b of the connection member 13 is joined to the second groove 121b of the plate 12. At this time, the first grooves 121a of the plurality of plates 12 and the first grooves 131a of the plurality of connection members 13 form a first guide groove 15a. The second grooves 121b of the plurality of plates 12 and the second grooves 131b of the plurality of connection members 13 form a second guide groove 15b.

The motor attachment part 14 is a part to which the first and second motors M1, M2 are attached. The motor attachment part 14 includes first and second motor mounts 141a, 141b and first and second joint portions 142a, 142b. The first motor M1 is attached to the first motor mount 141a. The second motor M2 is attached to the second motor mount 141b. The first joint portion 142a and the second joint portion 142b are positioned at both ends of the motor attachment part 14 in the circumferential direction. The first joint portion 142a of the motor attachment part 14 is turnably joined to the second joint portion 122b of a plate 12. The second joint portion 142b of the motor attachment part 14 is turnably joined to the first joint portion 122a of the plate 12.

### [1-3. First and Second Belts]

Each of the first and second belts 16a, 16b is, for example, an annular toothed belt, as an example. The first and second belts 16a, 16b are not limited thereto, and may be belts having no teeth, or may be chains or wires.

The first belt 16a is disposed in the first guide groove 15a and is driven by the first motor M1 so as to go around the guide rail 11. The second belt 16b is disposed in the second guide groove 15b and is driven by the second motor M2 so as to go around the guide rail 11. In other words, the first and second belts 16a, 16b are displaceable along the guide rail 11 independently of each other.

### [1-4. Motors]

The first and second motors M1, M2 output drive force for driving the moving unit 20. The first motor M1 is disposed on the first motor mount 141a and outputs drive force for displacing the first belt 16a along the guide rail 11. The second motor M2 is disposed on the second motor mount 141b and outputs drive force for displacing the second belt 16b along the guide rail 11.

### [1-5. Moving Unit]

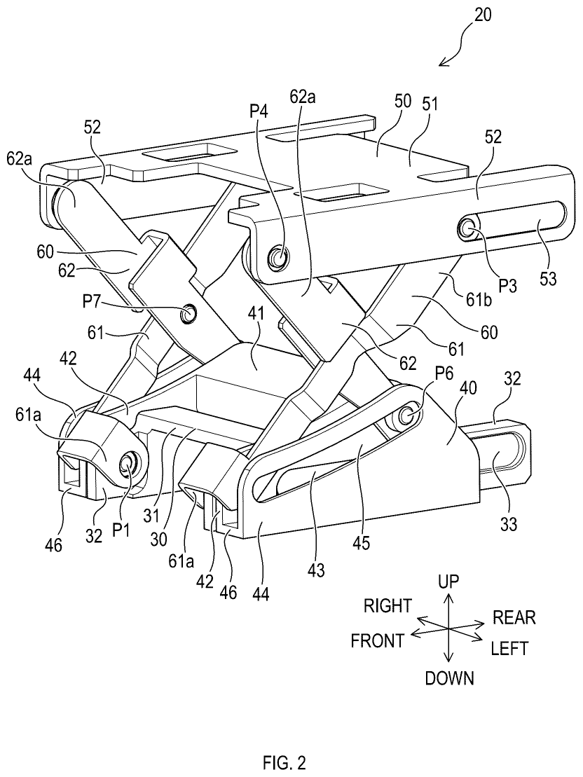

The moving unit 20 is a moving device displaceable along the guide rail 11. The moving unit 20 is disposed on the outer peripheral surface of the guide rail 11 (refer to FIGS. 1 and 2). When the moving unit 20 is disposed on the guide rail 11, a front-rear direction of the moving unit 20 is parallel to a direction in which the guide rail 11 extends. When the moving unit 20 is disposed on the guide rail 11, a left-right direction of the moving unit 20 is parallel to a width direction of the guide rail 11, and an up-down direction of the moving unit 20 is perpendicular to the outer peripheral surface of the guide rail 11. Hereinafter, a direction toward the outer peripheral side of the guide rail 11 along the up-down direction, in other words, a direction away from the guide rail 11, is defined as an upper side, and a direction opposite thereto is defined as a lower side.

The moving unit 20 has a symmetrical shape as an example, and includes first and second joint parts 30, 40, a displacement part 50, and at least one (two as an example) mechanism part 60 (refer to FIG. 2). Hereinafter, with respect to a central portion of the moving unit 20 in the left-right direction, each of sides on which ends in the left-right direction are positioned is defined as an outer side, and each of sides opposite to the outer sides is defined as an inner side.

### <First Joint Part>

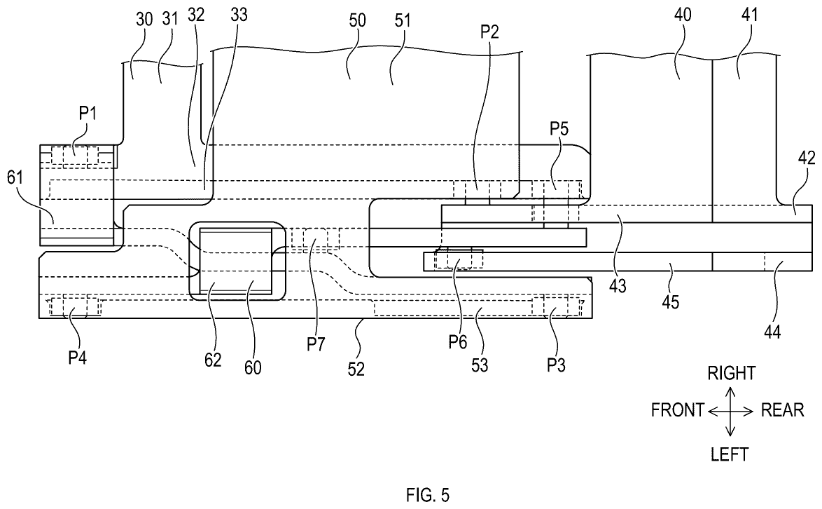

The first joint part 30 is a member joined to the first belt 16a. The first joint part 30 includes a bridge portion 31 and two rail portions 32 (refer to FIGS. 2, 3, and 5).

The bridge portion 31 is a plate-shaped portion extending in the left-right direction. A through-thickness direction of the bridge portion 31 is the up-down direction.

The two rail portions 32 are portions disposed at both ends of a lower surface of the bridge portion 31 in the left-right direction and extending forward and backward with respect to the bridge portion 31. Each rail portion 32 is positioned above the first and second guide grooves 15a, 15b. As an example, a right rail portion 32 of the two rail portions 32 is joined to the first belt 16a disposed in the first guide groove 15a. On an outer surface thereof, each rail portion 32 includes a slider groove 33 extending in the front-rear direction. A pin P1 is provided at a front end of an inner surface of each rail portion 32.

### <Second Joint Part>

The second joint part 40 is a member joined to the second belt 16b. The second joint part 40 includes a beam portion 41, two inner slider portions 42, and two outer slider portions 44 (refer to FIGS. 2 to 5).

The beam portion 41 is a pillar-shaped portion extending in the left-right direction and having a substantially triangular cross-sectional shape in a cross section orthogonal to the left-right direction. The beam portion 41 is disposed behind the bridge portion 31 and above the rail portions 32.

The two inner slider portions 42 are plate-shaped portions disposed at both ends of the beam portion 41 in the left-right direction. A through-thickness direction of the inner slider portions 42 is the left-right direction. Each inner slider portion 42 has a substantially triangular shape. Each inner slider portion 42 is disposed outside the rail portions 32.

Each inner slider portion 42 includes an elongated hole 43 extending along the front-rear direction. The elongated hole 43 is disposed at a position overlapping a slider groove 33.

The two outer slider portions 44 are plate-shaped portions disposed at both ends of the beam portion 41 in the left-right direction, and disposed outwardly apart from the inner slider portions 42. A through-thickness direction of the outer slider portions 44 is the left-right direction. Each outer slider portion 44 has a substantially triangular shape substantially the same as a shape of the inner slider portions 42. The inner slider portions 42 are connected to the outer slider portions 44 at connection portions 46 below the elongated holes 43. Each outer slider portion 44 includes an elongated hole 45 extending obliquely upward from front toward rear.

The inner slider portion 42 and outer slider portion 44 on a right side and the inner slider portion 42 and outer slider portion 44 on a left side are positioned above the first and second guide grooves 15a, 15b, respectively. As an example, the connection portion 46 connecting the inner slider portion 42 and outer slider portion 44 on the left side is joined to the second belt 16b.

A pin P2 is provided at a front end of an inner surface of each inner slider portion 42. The pin P2 is disposed in the slider groove 33 and is displaceable along the slider groove 33.

### <Displacement Part>

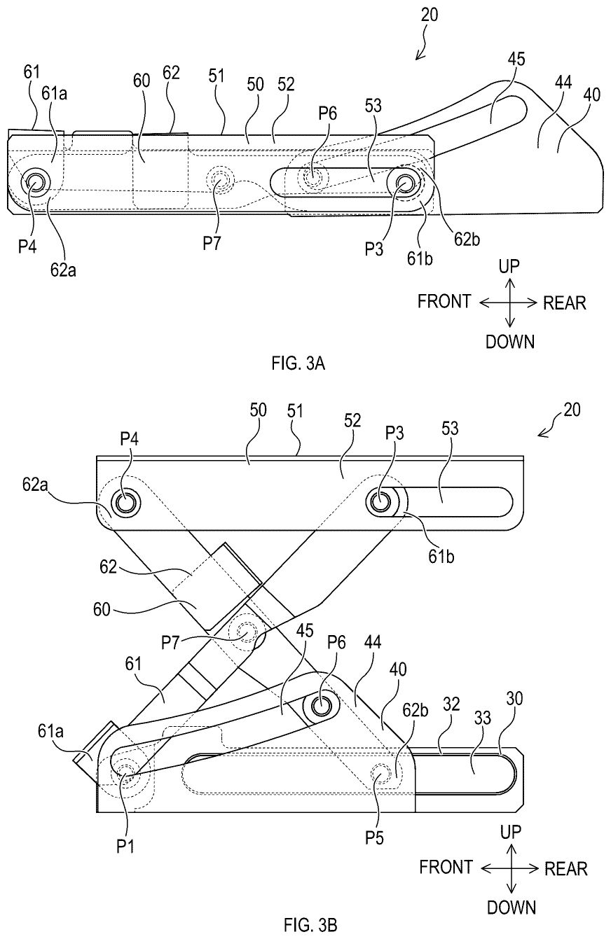

The displacement part 50 is a plate-shaped part and includes a top plate portion 51 and two edge portions 52 (refer to FIGS. 2 and 3).

The top plate portion 51 is a plate-shaped portion of which through-thickness direction is the up-down direction.

The two edge portions 52 are plate-shaped portions protruding downward from both ends of the top plate portion 51 in the left-right direction. Each edge portion 52 is at an outermost position in the moving unit 20. An elongated hole 53 extending along the front-rear direction is provided on a rear end side of each edge portion 52.

### <Mechanism Part>

The two mechanism parts 60 are mechanisms for displacing the displacement part 50 in the up-down direction (refer to FIGS. 2 to 5). Each mechanism part 60 according to the present embodiment is, as an example, a link mechanism using a pantograph-type X link mechanism. The mechanism parts 60 are disposed on both sides of the moving unit 20 in the left-right direction, and are joined to the first and second joint parts 30, 40.

Each mechanism part 60 includes first and second links 61, 62.

The first link 61 is an elongated plate-shaped member extending while being bent at a plurality of points. A first end 61a of the first link 61 is disposed inside a rail portion 32. A pin P1 in the rail portion 32 is turnably joined to the first end 61a of the first link 61.

A second end 61b of the first link 61 is disposed inside an edge portion 52 and outside an outer slider portion 44. A pin P3 is provided on an outer surface of the second end 61b of the first link 61. The pin P3 is disposed in the elongated hole 53 and is displaceable along the elongated hole 53.

The second link 62 is an elongated plate-shaped member extending while being bent at a plurality of points. A first end 62a of the second link 62 is disposed inside the edge portion 52, and a second end 62b of the second link 62 is disposed in a gap between an inner slider portion 42 and an outer slider portion 44 (refer to FIGS. 3 to 5).

A pin P4 is provided on an outer surface of the first end 62a of the second link 62, and a pin P5 is provided on an inner surface of the second end 62b of the second link 62. A pin P6 is provided on an outer surface near the second end 62b of the second link 62.

The pin P4 turnably joins a front end of an edge portion 52 of the displacement part 50 and the second link 62.

A pin P5 is disposed in the slider groove 33 and displaceable along the slider groove 33, and is disposed in the elongated hole 43 and displaceable along the elongated hole 43. That is, the pin P5 is displaceable in the front-rear direction with respect to the first joint part 30 and is also displaceable in the front-rear direction with respect to the second joint part 40. In the slider groove 33, the pin P5 is disposed behind the pin P2.

The pin P6 is disposed in the elongated hole 45 and is displaceable along the elongated hole 45. A shape of the elongated hole 45 (in other words, a shape of a path when the pin P6 is displaced) and a position where the pin P6 is provided in the second link 62 may be appropriately determined. Specifically, these may be appropriately determined such that a ratio of an amount the second joint part 40 is displaced in the front-rear direction with respect to the first joint part 30 to an amount the displacement part 50 is displaced in the up-down direction is an appropriate ratio. Not limited to extending in a gently curved shape as in the present embodiment, the elongated hole 45 may extend linearly, for example.

The first and second links 61, 62 intersect near centers thereof. When a portion where the first and second links 61, 62 intersect is defined as an intersection, a pin P7 is provided on an inner surface of the first link 61 at the intersection. The first and second links 61, 62 are turnably joined relatively by the pin P7.

### [1-6. Operation of Moving Unit]

Operation of the moving unit 20 according to the present embodiment will be described (refer to FIGS. 2 to 5).

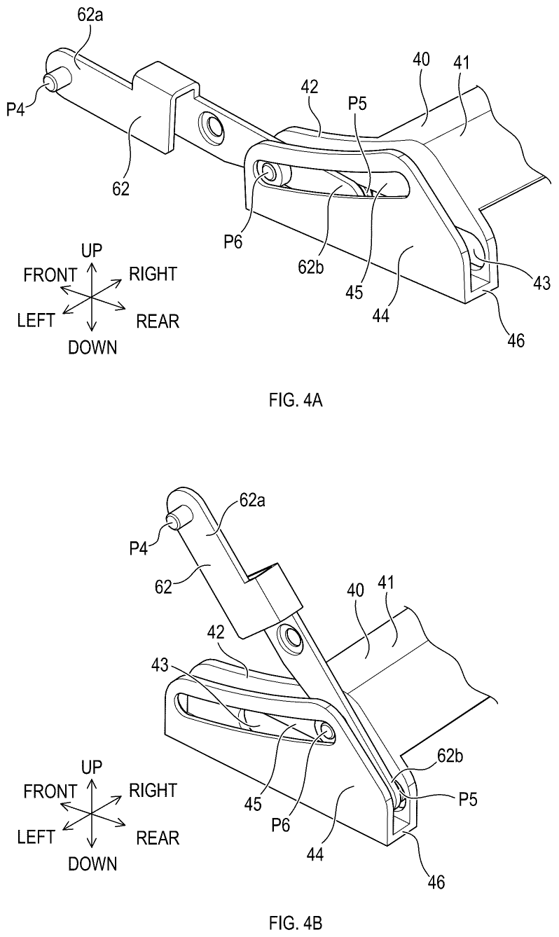

When the pin P4 is farthest from the pin P3, the first and second links 61, 62 are substantially parallel to the front-rear direction (refer to FIGS. 3A and 4A). At this time, the displacement part 50 is at a lowermost position thereof.

Here, when the second joint part 40 is relatively displaced forward (in other words, a side close to the pin P4), the pin P6 of the second link 62 is displaced upward as a result of being displaced along the elongated hole 45 (refer to FIGS. 3B and 4B). Thus, the second link 62 turns clockwise as viewed from the left side. As the pin P6 is displaced upward, the pin P4 is displaced upward, and the pin P5 is displaced forward.

As the second link 62 turns clockwise as viewed from the left side, the pin P7 is displaced upward. Thus, the first link 61 turns counterclockwise, and the pin P3 is displaced upward, and forward along the elongated hole 53. By the pin P4 and the pin P3 being displaced upward, the displacement part 50 is displaced upward.

When the moving unit 20 according to the present embodiment is disposed on the guide rail 11, the first and second joint parts 30, 40 are joined to the first and second belts 16a, 16b, respectively. Therefore, when the first and second belts 16a, 16b are displaced at an equal speed, relative positions of the first and second joint parts 30, 40 do not change. In this case, a position of the displacement part 50 in the up-down direction does not change, and the moving unit 20 is displaced along the guide rail 11.

Meanwhile, in a case where displacement speeds of the first and second belts 16a, 16b are different, or where either one is stationary and another is displaced, the relative positions of the first and second joint parts 30, 40 change. In this case, as the second joint part 40 is displaced forward relative to the first joint part 30, the displacement part 50 is displaced upward with respect to the guide rail 11. As the second joint part 40 is displaced rearward relative to the first joint part 30, the displacement part 50 is displaced downward with respect to the guide rail 11.

According to the present embodiment described in detail above, the following effects can be obtained.

### [1-7. Effects]

(1a) The drive force for driving the moving unit 20 is transmitted from the first and second motors M1, M2 to the moving unit 20 via the first and second belts 16a, 16b. Therefore, without incorporating a power source such as a motor into the moving unit 20, the moving unit 20 can be displaced along the guide rail 11, and the displacement part 50 can be displaced in the up-down direction with respect to the guide rail 11. Therefore, the moving unit 20 can be downsized.
(1b) When the second joint part 40 is at a rearmost position with respect to the first joint part 30, the first and second links 61, 62 are substantially parallel to the front-rear direction. At this time, because heights of the pins P1 to P7 in the up-down direction are substantially the same, it is difficult to turn the first and second links 61, 62 even if a force in the front-rear direction is applied to the first and second links 61, 62.

Meanwhile, in the present embodiment, because the pin P6 of the second link 62 is displaced along the elongated hole 45, an upward force is applied to the pin P6 when the second joint part 40 is displaced forward with respect to the first joint part 30. Therefore, the first and second links 61, 62 can be smoothly turned.
(1c) The plurality of plates 12, the plurality of connection members 13, and the motor attachment part 14 that constitute the guide rail 11 are turnably joined to each other. Therefore, when the unit driving apparatus 10 is mounted on the chair having a massage function, the guide rail 11 can be deformed so as to follow a body shape of the seated person in response to an external force received from the seated person. The moving unit 20 can be displaced along the body shape of the seated person, and a predetermined body part can be pressed by the displacement part 50. The predetermined body part can be rubbed by the moving unit 20 being displaced along the body shape while a state where the body part is pressed by the displacement part 50 is maintained.

### 2. Second Embodiment

### [2-1. Overall Configuration]

Next, a unit driving apparatus 10 according to a second embodiment will be described. The unit driving apparatus 10 according to the second embodiment is different from the unit driving apparatus 10 according to the first embodiment in a configuration of the moving unit 20. Hereinafter, the unit driving apparatus 10 according to the second embodiment will be described focusing on differences from the first embodiment.

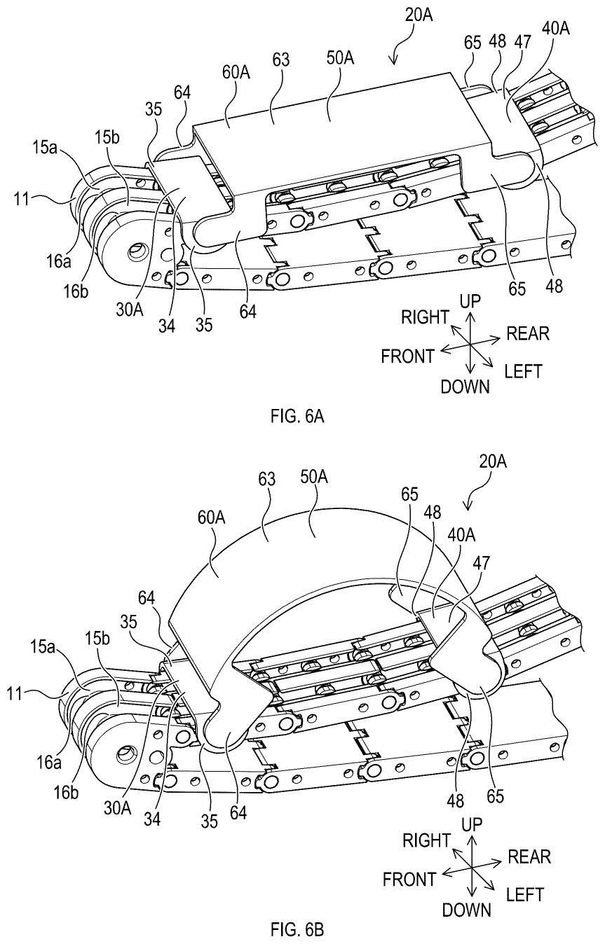

A moving unit 20A according to the second embodiment includes first and second joint parts 30A, 40A, a displacement part 50A, and a mechanism part 60A (refer to FIG. 6). When the moving unit 20A is disposed on an outer peripheral surface of a guide rail 11, a front-rear direction of the moving unit 20A is parallel to a direction in which the guide rail 11 extends, as in the first embodiment. A left-right direction of the moving unit 20A is parallel to a width direction of the guide rail 11, and an up-down direction of the moving unit 20A is perpendicular to the outer peripheral surface of the guide rail 11.

### <First Joint Part>

The first joint part 30A is a plate-shaped part and includes a flat plate portion 34 and two side plate portions 35. The flat plate portion 34 is a plate-shaped portion of which through-thickness direction is the up-down direction. The two side plate portions 35 are plate-shaped portions protruding downward from both ends of the flat plate portion 34 in the left-right direction. The flat plate portion 34 is positioned above first and second guide grooves 15a, 15b, and is joined to a first belt 16a disposed in a first guide groove 15a. The two side plate portions 35 are positioned outside the guide rail 11.

### <Second Joint Part>

A second joint part 40A is a plate-shaped part disposed behind the first joint part 30A and includes a flat plate portion 47 and two side plate portions 48. The flat plate portion 47 is a plate-shaped portion of which through-thickness direction is the up-down direction. The two side plate portions 48 are plate-shaped portions protruding downward from both ends of the flat plate portion 47 in the left-right direction. The flat plate portion 47 is positioned above the first and second guide grooves 15a, 15b, and is joined to a second belt 16b disposed in the second guide groove 15b. The two side plate portions 48 are positioned outside the guide rail 11.

### <Mechanism Part>

The mechanism part 60A includes a plate-shaped part 63, two first arm portions 64, and two second arm portions 65. The plate-shaped part 63 is a bendable plate-shaped part extending in the front-rear direction. A through-thickness direction of the plate-shaped part 63 is the up-down direction.

The two first arm portions 64 are elongated plate-shaped portions protruding downward from front ends at both ends of the plate-shaped part 63 in the left-right direction, and bend forward and extend. A tip end of each first arm portion 64 is turnably joined to a side plate portion 35.

The two second arm portions 65 are elongated plate-shaped portions protruding downward from rear ends at both the ends of the plate-shaped part 63 in the left-right direction, and bend rearward and extend. A tip end of each second arm portion 65 is turnably joined to a side plate portion 48.

### <Displacement Part>

The displacement part 50A is a portion of the plate-shaped part 63 (as an example, a central portion of the plate-shaped part 63).

### [2-2. Operation of Moving Unit]

Operation of the moving unit 20A according to the present embodiment will be described.

When the first joint part 30A is farthest from the second joint part 40A, the plate-shaped part 63 is flat (refer to FIG. 6A). In other words, a curvature of the plate-shaped part 63 is zero. Here, when the second joint part 40A is relatively displaced so as to approach the first joint part 30A, the first arm portion 64 turns counterclockwise and the second arm portion 65 turns clockwise, as viewed from the left side (refer to FIG. 6B). Thus, the plate-shaped part 63 is bent so as to protrude upward (in other words, the curvature of the plate-shaped part 63 increases). As the curvature of the plate-shaped part 63 increases, the displacement part 50A is displaced upward. Therefore, as the second joint part 40A is displaced forward and rearward relative to the first joint part 30A, the curvature of the plate-shaped part 63 changes, and the displacement part 50A is displaced in the up-down direction with respect to the guide rail 11.

### [2-3. Modifications]

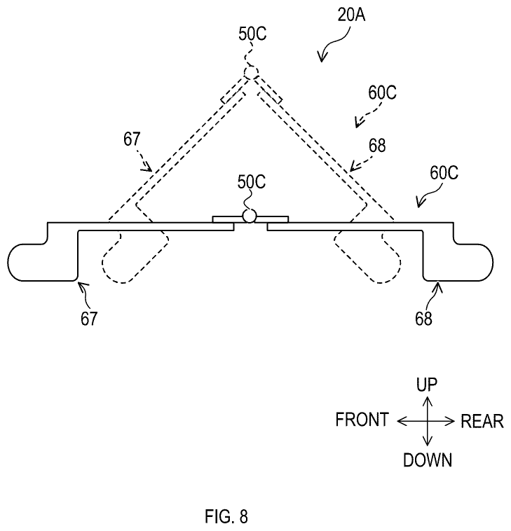

Instead of the mechanism part 60A and the displacement part 50A, the moving unit 20A may include a mechanism part 60C and a displacement part 50C. The mechanism part 60C may have a configuration in which the mechanism part 60A is divided at the central portion of the plate-shaped part 63 such that two divided members are aligned in the front-rear direction. Hereinafter, a front divided member of the mechanism part 60C is referred to as a first piece 67, and a rear divided member is referred to as a second piece 68. At this time, the displacement part 50C may be a member in which the first and second pieces 67, 68 are turnably joined to each other (as an example, a hinge) (refer to FIG. 8). In FIG. 8, the moving unit 20A is shown in solid lines when the displacement part 50C is lowered, and the moving unit 20A is shown in broken lines when the displacement part 50C is raised.

According to such a configuration, when the second joint part 40A is relatively displaced so as to approach the first joint part 30A, the first piece 67 turns counterclockwise and the second piece 68 turns clockwise, as viewed from the left side. Thus, the mechanism part 60C is bent at the displacement part 50C so as to protrude upward (in other words, an angle formed at the displacement part 50C by the first and second pieces 67, 68 is reduced). As the angle formed at the displacement part 50C by the first and second pieces 67, 68 decreases, the displacement part 50C is displaced upward. Therefore, as the second joint part 40A is displaced forward and rearward relative to the first joint part 30A, the angle formed at the displacement part 50C by the first and second pieces 67, 68 changes, and the displacement part 50C is displaced in the up-down direction with respect to the guide rail 11.

### [2-4. Effects]

According to the second embodiment described in detail above, effects similar to the effects (1a) and (1c) of the first embodiment can be obtained.

### 3. Other Embodiments

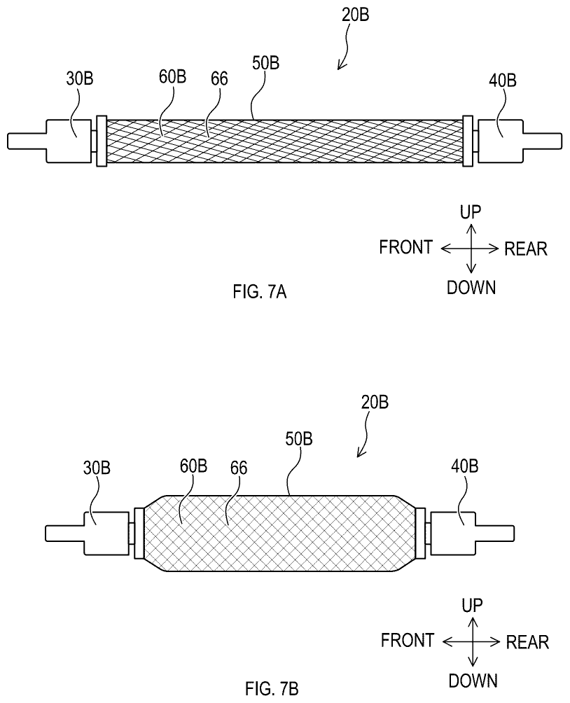

Although the embodiments of the present disclosure have been described above, it is needless to say that the present disclosure is not limited to the above-described embodiments and may take various forms.
(3a) In the first and second embodiments, the configurations of the moving units 20, 20A of the unit driving apparatus 10 have been exemplified. However, the configurations of the moving unit are not limited thereto. Specifically, for example, a mechanism part 60B of a moving unit 20B may be a cylindrical member having a grating peripheral wall 66 (refer to FIG. 7). At this time, first and second joint parts 30B, 40B may be members joined to both ends of the mechanism part 60B. A displacement part 50B may be a part of the peripheral wall 66 (as an example, a portion of the peripheral wall 66 positioned on an upside).

According to such a configuration, when the second joint part 40B is relatively displaced so as to approach the first joint part 30B, the peripheral wall 66 contracts in an axial direction and extends in a circumferential direction. As a result, the mechanism part 60B contracts in the axial direction and expands in a radial direction (refer to FIGS. 7A and 7B). Therefore, when the moving unit 20B is disposed on a guide rail 11, as the second joint part 40B is displaced relative to the first joint part 30B along the guide rail 11, the displacement part 50B is displaced in the up-down direction with respect to the guide rail 11.
(3b) For example, the mechanism part of the moving unit may include a bag capable of being filled with a fluid, and a pump joined to first and second joint parts. The displacement part may be a member joined to the bag. The pump may be configured to supply the fluid into the bag and suck the fluid in the bag. The mechanism part may be configured such that the pump changes an amount of the fluid filled in the bag, as the second joint part is displaced relative to the first joint part. With such a configuration, the amount of fluid filled in the bag may increase and decrease as the second joint part is displaced relative to the first joint part, and the displacement part may approach and leave the guide rail 11 by the bag expanding and contracting.
(3c) In the above-described embodiments, the guide rail 11 is a member having the plurality of plates 12, the plurality of connection members 13, and the motor attachment part 14 that are turnably joined to each other. However, the guide rail 11 is not limited thereto, and may be an integrally formed member.
(3d) The guide rail 11 in the above-described embodiments has an annular shape. However, the guide rail 11 is not limited thereto, and may have a linear shape, for example.
(3e) The guide rail 11 in the above-described embodiments includes the first and second guide grooves 15a, 15b, and the first and second belts 16a, 16b are disposed in the first and second guide grooves 15a, 15b, respectively. However, the guide rail 11 is not limited thereto, and may include one guide groove, for example. Then, the first and second belts 16a, 16b aligned in the width direction of the guide rail 11 may be disposed in one guide groove, and may be displaceable along the guide rail 11 independently of each other.
(3f) A plurality of functions of one component in the above-described embodiments may be implemented by a plurality of components, or one function of one component may be implemented by a plurality of components. In addition, a plurality of functions of a plurality of components may be implemented by one component, or one function implemented by a plurality of components may be implemented by one component. A part of a configuration of the above-described embodiments may be omitted. At least a part of the configuration of the above-described embodiments may be added to or replaced with any other configuration of the above-described embodiments.

### 4. Correspondence of Terms

The first belt 16a and the second belt 16b according to the first and second embodiments correspond to examples of first and second drive parts, respectively. The plurality of plates 12, the plurality of connection members 13, and the motor attachment part 14 according to the first and second embodiments correspond to examples of a plurality of joint members. The elongated hole 45 according to the first embodiment corresponds to an example of a guide, and the pin P6 according to the first embodiment corresponds to an example of a pin.

What is claimed is:

1. A unit driving apparatus comprising:
a guide rail extending in a longitudinal direction and including at least one guide groove extending along the longitudinal direction;
a moving unit configured to be displaceable along the guide rail; and
a first drive part and a second drive part that are disposed to extend along the longitudinal direction inside the at least one guide groove, and are configured to be displaceable along the longitudinal direction independently of each other, wherein
the moving unit includes:
a first joint part joined to the first drive part;
a second joint part joined to the second drive part and configured to be displaceable relative to the first joint part in the longitudinal direction;
a mechanism part joined to the first joint part and the second joint part; and
a displacement part configured to be displaceable so as to approach and leave the guide rail, and
the mechanism part is configured to displace the displacement part so that the displacement part approaches and leaves the guide rail as the second joint part is displaced relative to the first joint part in the longitudinal direction.

2. The unit driving apparatus according to claim 1, wherein
the guide rail includes a plurality of joint members aligned in the longitudinal direction while being turnably joined to each other.

3. The unit driving apparatus according to claim 1, wherein
the mechanism part includes a first link and a second link,
a first end side of the first link is turnably joined to the first joint part, and a second end side of the first link is turnably joined to the displacement part, and
a first end side of the second link is turnably joined to the second joint part, and a second end side of the second link is turnably joined to the displacement part.

4. The unit driving apparatus according to claim 3, wherein
the first link and the second link intersect each other, and are turnably joined to each other at a portion where the first link and the second link intersect each other.

5. The unit driving apparatus according to claim 4, wherein
the second joint part includes a guide extending obliquely along the longitudinal direction so as to leave the guide rail, from a side on which a portion where the first link and the first joint part are joined to each other is positioned toward a side on which a portion where the second link and the second joint part are joined to each other is positioned,
the second link includes a pin, and
the pin is disposed in the guide so as to be displaceable along a direction in which the guide extends.

6. The unit driving apparatus according to claim 1, wherein
the mechanism part includes a plate-shaped part that is bendable and extending along the longitudinal direction,
the displacement part is a part of the plate-shaped part, and
the mechanism part is configured to change a curvature of a curve of the plate-shaped part as the second joint part is displaced relative to the first joint part in the longitudinal direction.

7. The unit driving apparatus according to claim 1, wherein
the mechanism part includes a first piece turnably joined to the first joint part, a second piece turnably joined to the second joint part,
the displacement part is a part that turnably joins the first piece and the second piece to each other, and
the mechanism part is configured to change an angle formed at the displacement part by the first piece and the second piece, as the second joint part is displaced relative to the first joint part in the longitudinal direction.

8. The unit driving apparatus according to claim 1, wherein
the guide rail includes a first guide groove and a second guide groove as at least one guide groove,
the first drive part is disposed inside the first guide groove, and
the second drive part is disposed inside the second guide groove.

9. The unit driving apparatus according to claim 1, further comprising:
a first motor that outputs drive force for displacing the first drive part; and
a second motor that outputs drive force for displacing the second drive part.

10. The unit driving apparatus according to claim 1, wherein
the unit driving apparatus is mounted on a chair, and
the unit driving apparatus is configured to press a body part of a seated person on the chair by displacing the displacement part so that the displacement part leaves the guide rail.
